(19) United States
(12) Patent Application Publication
(10) Pub. No.: US 2020/0355986 A1
(43) Pub. Date: Nov. 12, 2020

(54) LED LENS STRUCTURE AND TRAIL CAMERA

(71) Applicant: Guangdong Outdoor Technology Limited, Dongguan (CN)

(72) Inventors: Dajun Dong, Dongguan (CN); Ping Ma, Dongguan (CN); Peibin Xu, Dongguan (CN); Tuqian Wu, Dongguan (CN)

(21) Appl. No.: 16/941,698

(22) Filed: Jul. 29, 2020

(30) Foreign Application Priority Data
Jul. 6, 2020 (CN) 202010639080.0

(51) Int. Cl. G03B 15/03; F21V 5/04; F21V 23/04; H05B 45/10; H05B 47/11; H05B 47/13

(52) U.S. Cl. CPC G03B 15/03; F21V 5/04; F21V 23/0464; F21Y 2115/10; H05B 45/10; H05B 47/11; H05B 47/13; F21V 23/0471

(57) ABSTRACT

A LED lens structure, configured to supply auxiliary photographing light for photographing equipment, includes a base and a LED light emitting chip formed on the base. An encapsulating lens formed by encapsulating silica gel is formed on the LED light emitting chip, and the encapsulating lens has an ellipsoid structure and provides a light exit surface that is an ellipsoid surface. The LED light source can project an approximately rectangular light spot on the light-receiving surface, and the imaging area of the trail camera is also rectangular, thus the light emitted by the LED light source can fall into the imaging area as much as possible, thereby improving effective utilization of light source, which can reduce the power of auxiliary lighting source, and effectively reduce the interference of the reflected light on the ground beyond the imaging area to the trail camera, thereby improving the image quality.

### FIELD OF THE INVENTION

The present invention relates to the field of camera assisted lighting technology, in particular to an LED lens structure and a trail camera.

### BACKGROUND OF THE INVENTION

The trail camera is mainly used for automatic photo surveillance in a certain area. When the object to be monitored enters the surveillance area and sensed by the sensor on the camera, the camera captures pictures, and the captured pictures will be stored for viewing and analysis. Nowadays, trail cameras are widely used in animal protection and hunting industries. Since many animals are mainly active at night, the image quality of pictures taken by trail cameras at night is particularly important.

At present, most trail cameras use infrared LEDs for auxiliary lighting when taking pictures at night. These LEDs illuminate in a circular area, which has two problems: (1) As shown in FIG. 5, the imaging area M0 of the trail camera is quadrilateral, but the light spot B0 provided by the light source L is circular, therefore, a part of the light certainly will be projected outside the imaging area M0, causing energy loss; (2) Because a part of the light is projected outside the imaging area M0, especially to the ground in front of the trail camera, therefore the reflected light from the ground will return to the lens, reducing the imaging quality.

Therefore, it is necessary to improve the photographing auxiliary light source of the existing trail camera.

### SUMMARY OF THE INVENTION

One objective of the present invention is to provide a LED lens structure, so as to enable the LED light source to emit an approximately rectangular light spot to the target light-receiving surface.

Another objective of the present invention is to provide a trail camera, which supply an auxiliary photographing light source to emit an approximately rectangular light spot.

To achieve above-mentioned objectives, the present invention provides a LED lens structure, configured to supply auxiliary photographing light for photographing equipment, and the LED source package structure includes a base, and a LED light emitting chip formed on the base. The an encapsulating lens formed by encapsulating silica gel is formed on the LED light emitting chip, the encapsulating lens has an ellipsoid structure and provides a light exit surface that is an ellipsoid surface.

Preferably, a length scale of a long axis to a short axis of the ellipsoid surface of the encapsulating lens is 16:9.

Preferably, the LED light emitting chip is configured to emit an infrared light.

The present invention further provides a trail camera including a camera body provided with at least one LED light source for auxiliary photographing lighting, wherein the LED light source has a LED lens structure mentioned above.

Preferably, the camera body is provided with a lamp panel, multiple LED light sources are formed on the lamp panel and arranged in a same plane.

Preferably, the camera body is provided with a controller electrically connected to the multiple LED light sources, for controlling to selectively turn on or turn off any one of the multiple LED light sources.

Preferably, the camera body is provided with a luminance sensor electrically connected to the controller for detecting brightness of surrounding environment, and the controller is configured to adjust state of the LED light sources according to a detection value detected by the luminance sensor.

Preferably, the camera body is provided with an infrared motion sensor electrically connected to the controller for triggering a photographing action of the camera body, and the controller is configured to control state of the LED light sources according to data detected by the infrared motion sensor.

In comparison with the prior art, because the encapsulating lens of the LED light source for auxiliary photographing lighting has an ellipsoid structure, and the LED light source can project an approximately rectangular light spot on the light-receiving surface, and the imaging area of the trail camera is also rectangular, thus the light emitted by the LED light source can fall into the imaging area as much as possible, thereby improving effective utilization of light source, which can reduce the power of auxiliary lighting source. In addition, the amount of the light emitted from the LED light source falling beyond the imaging area is small, which can effectively reduce the interference of the reflected light on the ground beyond the imaging area to the trail camera, thereby improving the image quality.

### BRIEF DESCRIPTION OF THE DRAWINGS

The accompanying drawings facilitate an understanding of the various embodiments of this invention. In such drawings:

FIG. 1 is a schematic cross-sectional view of an LED light source according to an embodiment of the present invention;

FIG. 2 is a schematic plan view of a camera body according to an embodiment of the present invention;

FIG. 3 is a schematic diagram showing the matching status of a light spot projected by a camera body and an imaging area according to an embodiment of the present invention;

FIG. 4 is a schematic diagram of the control principle of the camera body according to an embodiment of the present invention; and

FIG. 5 is a schematic diagram showing the matching status of a light spot projected by a trail camera light source and an imaging area in the prior art.

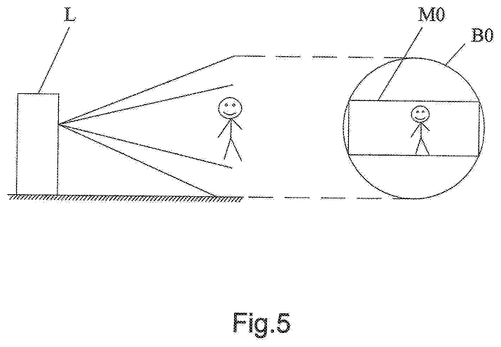

### DETAILED DESCRIPTION OF ILLUSTRATED EMBODIMENTS

A distinct and full description of the technical solution of the present invention will follow by combining with the accompanying drawings.

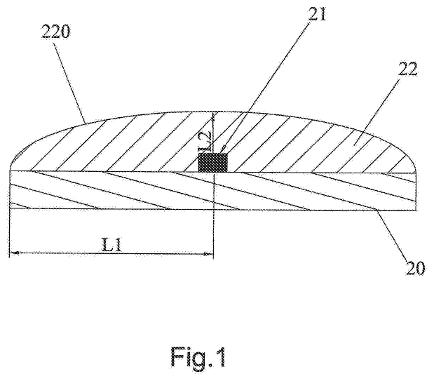

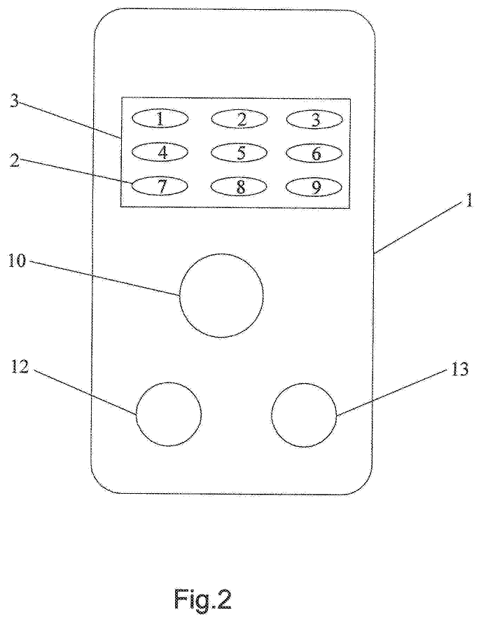

As shown in FIGS. 1 and 2, a trail camera according to one embodiment of the present invention includes a camera body and at least one LED light source 2 configured on the camera body 1 for auxiliary photographing lighting. In the present embodiment, the LED light source 2 is packaged and its package structure includes a base 20 and a LED light emitting chip formed on the base 20, an encapsulating lens 22 formed by encapsulating silica gel is covered on the LED light emitting chip 21, and the encapsulating lens 22 has an ellipsoid structure and provides a light exit surface that is an ellipsoid surface 220. By controlling the scale of the long axis and the short axis of the ellipsoidal surface 220, the light spot projected by the LED light source 2 can be control as an approximate rectangle, so that the light projected by the LED light source 2 falls into the imaging area of the camera body 1 as much as possible. Since the size of most photos is a rectangle with a scale of 16:9, thus the length scale of the long axis L1 to the short axis L2 of the ellipsoidal surface 220 of the encapsulating lens 22 is 16:9, preferably,.

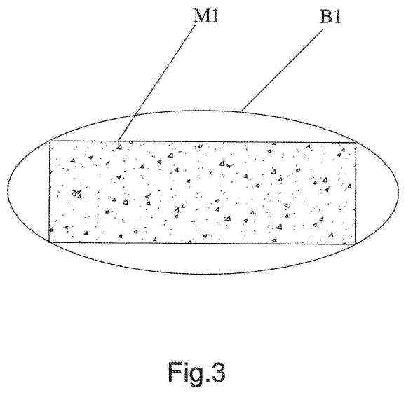

When using the trail camera with the above structure for surveillance, please refer to FIGS. 1 to 3, the position of the camera body 1 can be adjusted according to the target monitoring area, so that the light spot B1 projected by the LED light source 2 is equivalent to the area of the imaging area M1. Since the LED light source 2 can project an approximately rectangular light spot B1 on the light-receiving surface, and the imaging area M1 of the trail camera is also rectangular, thus the light emitted by the LED light source 2 can fall into the imaging area M1 as much as possible, thereby improving effective utilization of light source, which can reduce the power of auxiliary lighting source. In addition, the amount of the light emitted from the LED light source 2 falling beyond the imaging area M1 is small, which can effectively reduce the interference of the reflected light on the ground beyond the imaging area M1 to the trail camera, thereby improving the image quality. Preferably, the light emitted by LED emitting chip 21 is an infrared light, which has small volume, low power consumption as well as good directivity.

As shown in FIG. 2, the camera body 1 is provided with a lamp panel 3, a plurality of LED light sources 2 are formed on the lamp panel 3 and arranged in a same plane and aligned along a square shape. In such an arrangement for the LED light sources 2, the power of each LED light source can be reduced, and the cost is reduced, thereby extending the lifetime of the light source.

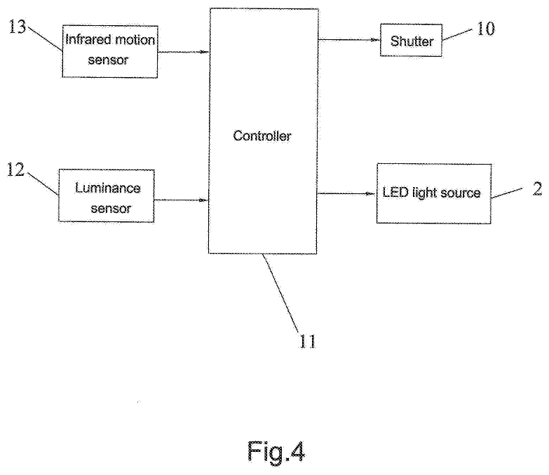

Preferably, please refer to FIGS. 2 and 4, the camera body 1 is further provided with a controller 11 electrically connected to the plurality of LED light sources 2, for controlling to selectively turn on or turn off any one of the plurality of LED light sources 2. The number of LED light sources 2 to be turned on can be selected by the controller 11, so as to control the size of the light spot B1 projected to the monitoring area. It should be noted that, when selecting the LED light sources 2, the light-emitting surface composed of the currently selected lighted LED light source 2 should be rectangular. As shown in FIG. 2, nine LED light sources 2 numbered 1 to 9, respectively, are configured. For example, the LEDs 1-3 can be turned on synchronously, or LEDs 1, 2, 4, 5 can be turned on synchronously, to obtain a rectangular light-emitting surface; instead, it's undesired to just turn on LEDs 1-7 without LEDs 8-9.

Furthermore, the camera body 1 is further provided with a luminance sensor 12 electrically connected to the controller 11 for detecting the luminance of the surrounding environment. The controller 11 can control the state of the LED light source 2 according to the detection value detected by the luminance sensor 12. In this embodiment, by the luminance sensor 12, the camera body 1 can automatically judge whether to use the LED light sources 2 to assist the photographing operation, or adjust the working luminance of the LED light source 2, according to the surrounding environment, which not only saves the energy supply of the camera body 1 but also effectively improves the imaging quality.

Preferably, the camera body 1 is further provided with an infrared motion sensor 13 electrically connected to the controller 11. The infrared motion sensor 13 is used to trigger the camera body 1 to take a photo action. At the same time, the controller 11 can feed back the state of the LED light source 2 basing on the infrared motion sensor 13. When the infrared motion sensor 13 detects that a living object is approaching, the controller 11 controls the shutter 10 of the camera body 1 to start while turning on the LED light sources 2. When the camera body 1 is in the non-photographing state, the LED light sources 2 are in the off state.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A LED lens structure, configured to supply auxiliary photographing light for photographing equipment, and the LED source package structure comprising:
a base; and
a LED light emitting chip formed on the base;
wherein an encapsulating lens formed by encapsulating silica gel is formed on the LED light emitting chip, and the encapsulating lens has an ellipsoid structure and provides a light exit surface that is an ellipsoid surface.

2. The LED lens structure according to claim 1, wherein a length scale of a long axis to a short axis of the ellipsoid surface of the encapsulating lens is 16:9.

3. The LED lens structure according to claim 1, wherein the LED light emitting chip is configured to emit an infrared light.

4. A trail camera comprising a camera body provided with at least one LED light source for auxiliary photographing lighting, wherein the LED light source has a LED lens structure according to claim 1.

5. The trail camera according to claim 4, wherein the camera body is provided with a lamp panel, multiple LED light sources are formed on the lamp panel and arranged in a same plane.

6. The trail camera according to claim 5, wherein the camera body is provided with a controller electrically connected to the multiple LED light sources, for controlling to selectively turn on or turn off any one of the multiple LED light sources.

7. The trail camera according to claim 6, wherein the camera body is provided with a luminance sensor electrically connected to the controller for detecting brightness of surrounding environment, and the controller is configured to adjust state of the LED light sources according to a detection value detected by the luminance sensor.

8. The trail camera according to claim 6, wherein the camera body is provided with an infrared motion sensor electrically connected to the controller for triggering a photographing action of the camera body, and the controller is configured to control state of the LED light sources according to data detected by the infrared motion sensor.
